(19) United States
(12) Patent Application Publication
(10) Pub. No.: US 2015/0248636 A1
(43) Pub. Date: Sep. 3, 2015

(54) SCHEDULED COMPONENT RETIREMENT SYSTEM AND METHOD FOR SHIPPING CONTAINER COMPONENTS

(71) Applicants: Richard C. PETERS, (US); MINNESOTA THERMAL SCIENCE, LLC, Plymouth, MN (US)

(72) Inventor: Richard C. Peters, Woodbury, MN (US)

(21) Appl. No.: 14/430,733

(22) PCT Filed: Sep. 25, 2013
(86) PCT No.: PCT/US13/61672

§ 371 Date: Mar. 24, 2015

Related U.S. Application Data
(60) Provisional application No. 61/705,382, filed on Sep. 25, 2012.

(51) Int. Cl. G06Q 10/08

(52) U.S. Cl. CPC G06Q 10/0832

(57) ABSTRACT

A system and method for scheduled, trip-based retirement of reused passive thermal control shipping container components. A wide variety of goods are thermally labile and therefore need to be maintained above and/or below a target temperature at all times to prevent spoilage, decomposition, deactivation, transformation, conversion, breakdown, etc. Exemplary thermally labile goods include blood, blood products such as red blood cells (RCBs) and blood platelets, transplantable organs, biological tissue, vaccines, antigens, antibodies, bacteriological samples, immunoassays, pharmaceuticals, enzymes, and single-use chromogenic thermometers.

This application claims the benefit of U.S. Provisional Application No. 61/705,382, filed Sep. 25, 2012.

### BACKGROUND

A wide variety of goods are thermally labile and therefore need to be maintained above and/or below a target temperature at all times to prevent spoilage, decomposition, deactivation, transformation, conversion, breakdown, etc. Exemplary thermally labile goods include blood, blood products such as red blood cells (RCBs) and blood platelets, transplantable organs, biological tissue, vaccines, antigens, antibodies, bacteriological samples, immunoassays, pharmaceuticals, enzymes, and single-use chromogenic thermometers.

Thermally insulted shipping containers are widely used to transport thermally labile goods from a manufacturing or distribution facility, such as a blood collection center, to the end user, such as a hospital. Numerous insulated shipping containers have been developed over the years, with those deploying a phase change material generally providing superior temperature control over extended periods. A nonexhaustive list of United States patents and Published Patent Applications disclosing insulated shipping containers employing a phase change material, hereinafter referenced as passive thermal control shipping containers or simply shipping containers, include U.S. Pat. Nos. 4,145,895; 4,579,170; 4,923,077; 4,931,333; 5,626,936; 5,899,088; 6,209,343; 6,718,776; 7,257,963; 7,422,143; 7,500,593 and 8,424,335, and United States Patent Application Publications 2002/0050147; 2005/0188714, and 2011/0248038, 2013/0228583.

Typical passive thermal control shipping containers are assembled from separate and independent modular components, including an outer structural shell, thermal insulation panels (TIP panels) and phase change material panels (PCM panels), as this facilitates thermal conditioning of the PCM panels prior to each trip.

Quality shipping containers capable of reliably maintaining a payload within a narrow thermal window over an extended period of time are generally desired by manufacturing and distribution facilities as they greatly increase customer satisfaction and reduce shrinkage by consistently and reliably maintaining thermal integrity during transport. The high cost of such quality shipping containers has prompted the development of reverse logistics shipping systems designed to recover and allow reuse of the shipping container components.

Shipping container components, as with all things, eventually fail due to ordinary wear and tear. Unfortunately, the components used in assembly of quality passive thermal control shipping containers often do not show signs of failure, resulting in the discovery and identification of failed and/or failing components only after a shipping container containing the component fails to maintain the necessary thermal integrity during a trip, thereby resulting in loss of the thermally labile payload and a dissatisfied customer.

Accordingly, a substantial need exists for a system and method of facilitating the identification and replacement of failed and/or failing passive thermal control shipping container components before they fail during shipment of a payload.

### SUMMARY OF THE INVENTION

A first aspect of the invention is a scheduled component retirement system for passive thermal control shipping containers employed in a delivery and recovery reverse logistics shipping system. The system includes at least a computer operable for capturing and storing trip information relating to each of a plurality of shipping containers and shipping container components. The system is programmed and operable for (A) capture of inventory data indicating inventory of shipping container components managed by a management facility and a unique identifier applied to each shipping container component in inventory, (B) capture of trip data for each shipping container component indicating the trip count for by each component, and (C) generating a component utilization report including at least one of (-) a listing of components identified by the component's unique identifier, and trip count for each component, grouped by type of component and sorted by trip count, and (-) a listing of components, identified by the component's unique identifier and grouped by type of component, having a trip count exceeding a threshold number of trips suggestive of a component to be retired.

The inventory of shipping container components preferably includes at least the separate and independent components of (-) a plurality of outer shells defining a chamber, (-) a plurality of thermal insulation panels configured and arranged for lining a chamber to define a thermally insulated chamber, and (-) a plurality of phase change material panels configured and arranged for lining a thermally insulated chamber to define a thermal control chamber.

The components may be modular components, whereby each assembled shipping container may be formed from a different collection of components for each trip. The system can capture trip data for each shipping container component even though the collection of components used in the assembly of each shipping container may vary from trip to trip by (-) correlating the unique identifier of each shipping container component used in assembly of the shipping container prior to commencement of a trip, (-) inputting the unique identifier for a single one of the shipping container components used in assembly of the shipping container upon completion of a trip, and (-) automatically incrementing the trip count for each of the correlated components.

A second aspect of the invention is a method for scheduled component retirement of recovered and reused passive thermal control shipping container components employing a computer with a computer database.

The second aspect of the invention includes the steps of: (a) capturing trip count in the computer database for each shipping container component by: (-) correlating the unique identifier of each shipping container component used in assembly of the shipping container prior to commencement of a trip in the computer database, (-) inputting into the computer database, upon completion of a trip and recovery of a shipping container, the unique identifier for a single one of the recovered shipping container components, and (-) automatically incrementing the trip count for each of the correlated components in the recovered shipping container, (b) automatically identifying components, by the component's unique identifier, having a trip count exceeding a threshold number of trips, indicating the component is scheduled for retirement, and (c) retiring components identified as a component scheduled for retirement.

The computer can automatically generate a real-time human perceptible notification signal when a recovered shipping container contains a component scheduled for retirement.

### BRIEF DESCRIPTION OF THE DRAWINGS

FIG. 1A is an assembly drawing for an exemplary passive thermal control shipping container.

FIG. 1B is an exemplary trip report generated during assembly of the shipping container depicted in FIG. 1A wherein one of the components has been identified as a component scheduled for retirement.

FIG. 2 is an isometric view of the assembled shipping container depicted in FIG. 1A after replacement of the component scheduled for retirement and an exemplary trip report generated for the assembled shipping container after shipment and prior to recovery.

FIG. 3 is an isometric view of the shipping container depicted in FIG. 2 upon recovery, and an exemplary trip report generated for the recovered shipping container wherein one of the components has been identified as a component scheduled for retirement.

FIG. 4 is an exemplary component utilization ageing report, sorted by trip number.

### DETAILED DESCRIPTION OF A PREFERRED EMBODIMENT

### Definitions

As used herein, including the claims, the phrase “management facility” means a facility equipped to (i) thermally condition PCM panels, (ii) assemble passive thermal control shipping containers with thermally conditioned PCM panels, (iii) coordinate transport of assembled shipping containers to at least one distribution facility, and (iv) receive empty, thermally spent passive thermal control shipping containers for inspection, cleaning, refurbishment, repair, replacement and/or disposal of the shipping container components (i.e., outer structural shell, thermal insulation panels, PCM panels, etc.), for subsequent thermal reconditioning and reuse of some or all of the shipping container components.

As used herein, including the claims, the phrase “distribution facility” means a facility equipped to (i) load a thermally labile payload into thermally conditioned passive thermal control shipping containers, and (ii) coordinate transport of loaded shipping containers to at least one customer facility (e.g., a blood bank or a pharmaceutical distribution center).

As used herein, including the claims, the phrase “customer facility” means a facility that purchases thermally labile goods for use or for supply to an individual end-user of the goods (e.g., a hospital or a pharmacy).

As used herein, including the claims, the term “trip”, when used in connection with a shipping container or shipping container components, means a round trip shipment out from and back to a management facility with the expectation that the shipping container will be used to ship a payload placed within the shipping container.

As used herein, including the claims, the term “trip count”, when used in connection with a shipping container or shipping container component, means the cumulative number trips taken by the shipping container or shipping container component.

Nomenclature Table

| | |
|---|---|
| 10 | Shipping Container |
| 10ₐ | Outgoing Shipping Container |
| 10_{b} | Incoming Shipping Container |
| 20 | Outer Structural Shell |
| 21 | Structural Shell Identification Label |
| 30 | Thermal Insulation Panels (TIP Panel) |
| 31 | TIP Panel Identification Label |
| 40 | Phase Change Material Panels (PCM Panels) |
| 41 | PCM Panel Identification Label |
| 80 | Barcode Reader |
| 90 | Computer |
| 101 | Trip Report |
| 102 | Component Utilization Aging Report |

### Description

The invention is directed to a system and method for scheduled retirement of reused passive thermal control shipping container components.

### Passive Thermal Control Shipping Container 10

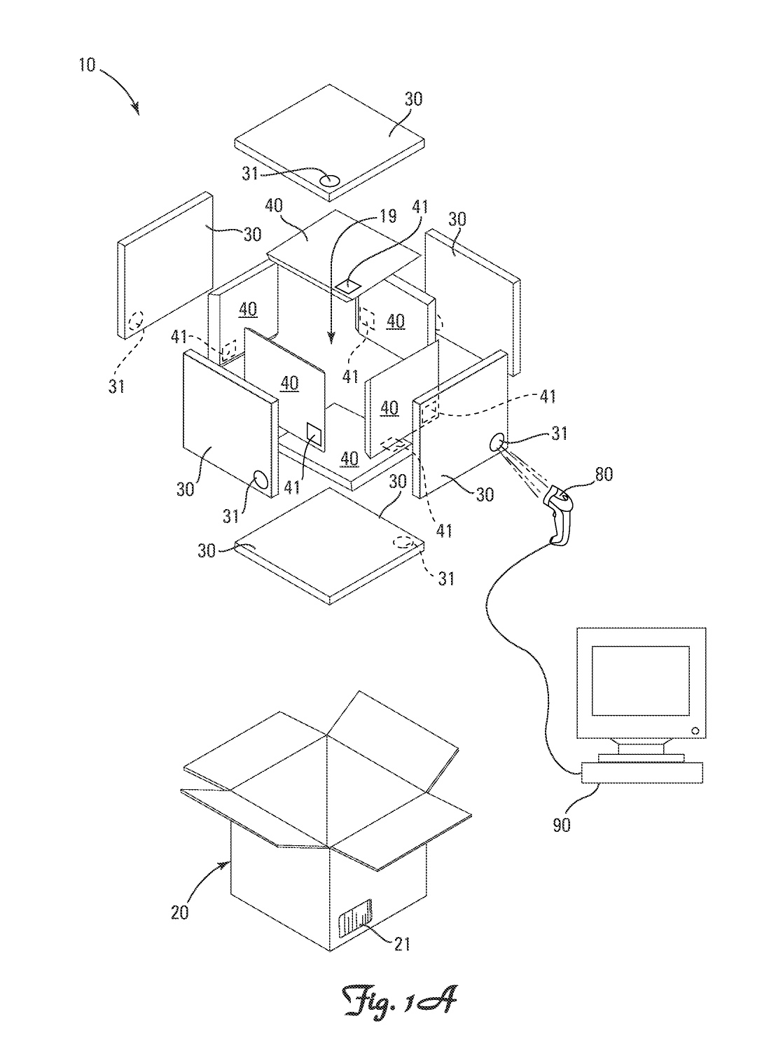

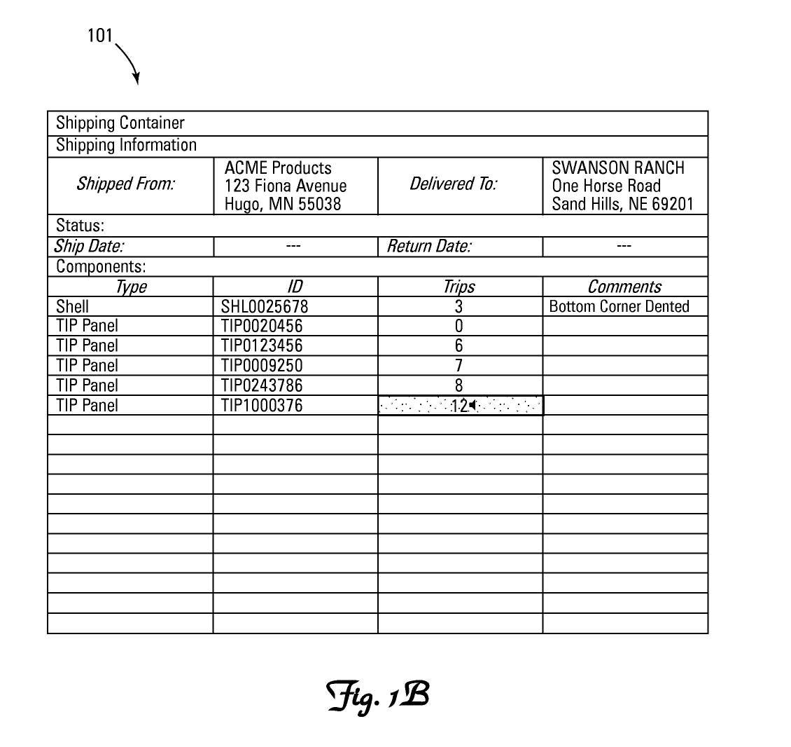

Referring generally to FIG. 1A, passive thermal control shipping containers 10 suitable for use in the present invention include an outer structural shell 20, thermal insulation 30 and PCM panels 40. These components may be provided as separate and independent components or may be combined into integrated units (e.g., an outer structural shell 20 filled with thermal insulation 30, a panel of thermal insulation 30 adhesively attached to a PCM panel 40, etc.). Substantially any passive thermal control shipping container 10 can be employed in the present invention, including those disclosed in U.S. Pat. Nos. 4,145,895; 4,579,170; 4,923,077; 4,931,333; 5,626,936; 5,899,088; 6,209,343; 6,718,776; 7,257,963; 7,422,143; 7,500,593 and 8,424,335, and United States Patent Application Publications 2002/0050147; 2005/0188714, and 2011/0248038, 2013/0228583, the disclosures of which are hereby incorporated by reference.

Referring to FIG. 1A, each component has a label bearing a unique identification number. For the embodiment depicted in FIG. 1, the outer structural shell 20 has a structural shell identification label 21, the panels of thermal insulation 30 (TIP panels) each have a TIP panel identification label 31, and the phase change material panels 40 (PCM panels) each have a PCM panel identification label 41. The ID numbers are preferably machine readable code, such as a bar code, adhesively applied at the same general location (e.g., lower right back corner) on each component to facilitate scanning of the label prior to each trip.

### Physical Trips

Shipping containers 10 assembled from the components available in inventory at a given management facility, presenting the structural shell identification label 21 throughout the trip, travel through delivery and recovery loops (i.e., trips) that typically include a management facility, a distribution facility and a customer facility. Movement of the shipping containers 10 between facilities can be accomplished by utilizing the services of an existing third party courier such as DHL, FedEx, UPS, USPS, etc.

### Trip Data

Referring to FIGS. 1A and 1B, the unique identification number of each component selected for use in assembly of a shipping container 10 is input into a database on a computer 90, such as by scanning the barcode on each ID label with a barcode reader 80, prior to commencement of each trip. As they are entered into the database, the ID numbers are correlated to indicate that they have been assembled into a given shipping container 10 and will be traveling together on a given trip. In the event a component entered into the database is scheduled for retirement, as having a trip count exceeding a threshold number of trips at which the component is to be retired, the computer 90 may be programmed to automatically generate a real-time human perceptible notification signal, such as an audible tone and/or display of a flashing light, so that the component may be promptly identified and replaced.

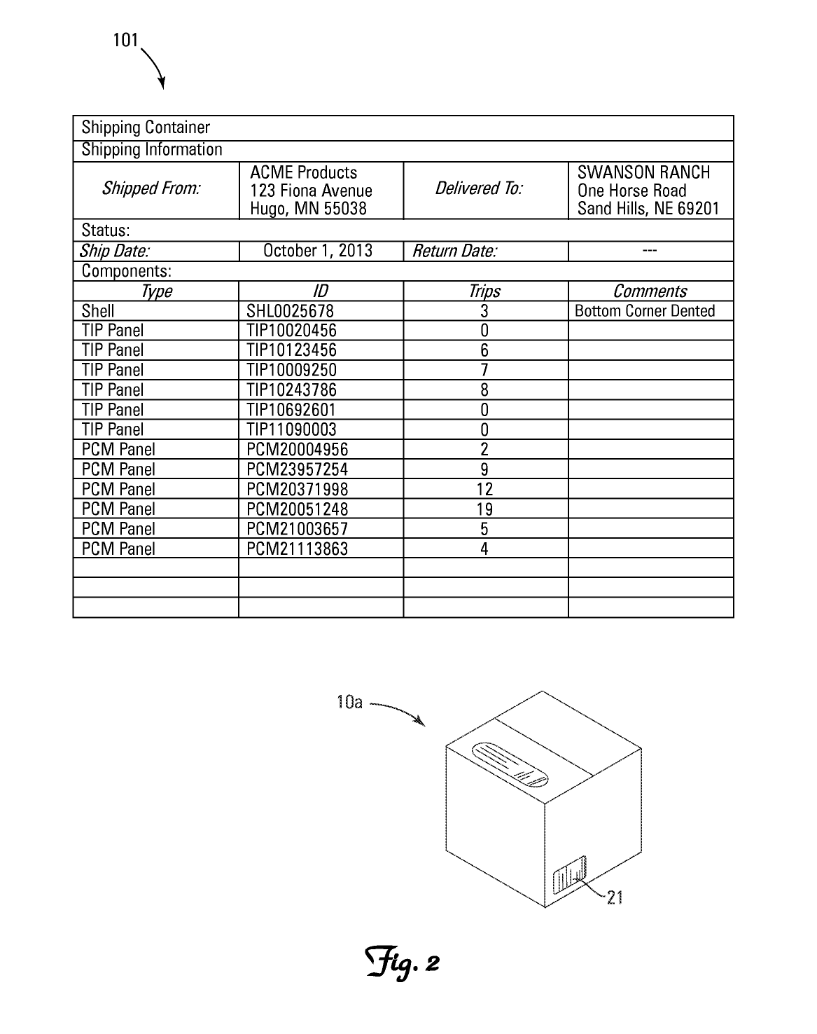

FIG. 2 depicts one embodiment of a fully assembled outgoing shipping container 10a and an exemplary trip report 101 for the outgoing shipping container 10a listing, identifying and correlating all of the components used in the given shipping container 10.

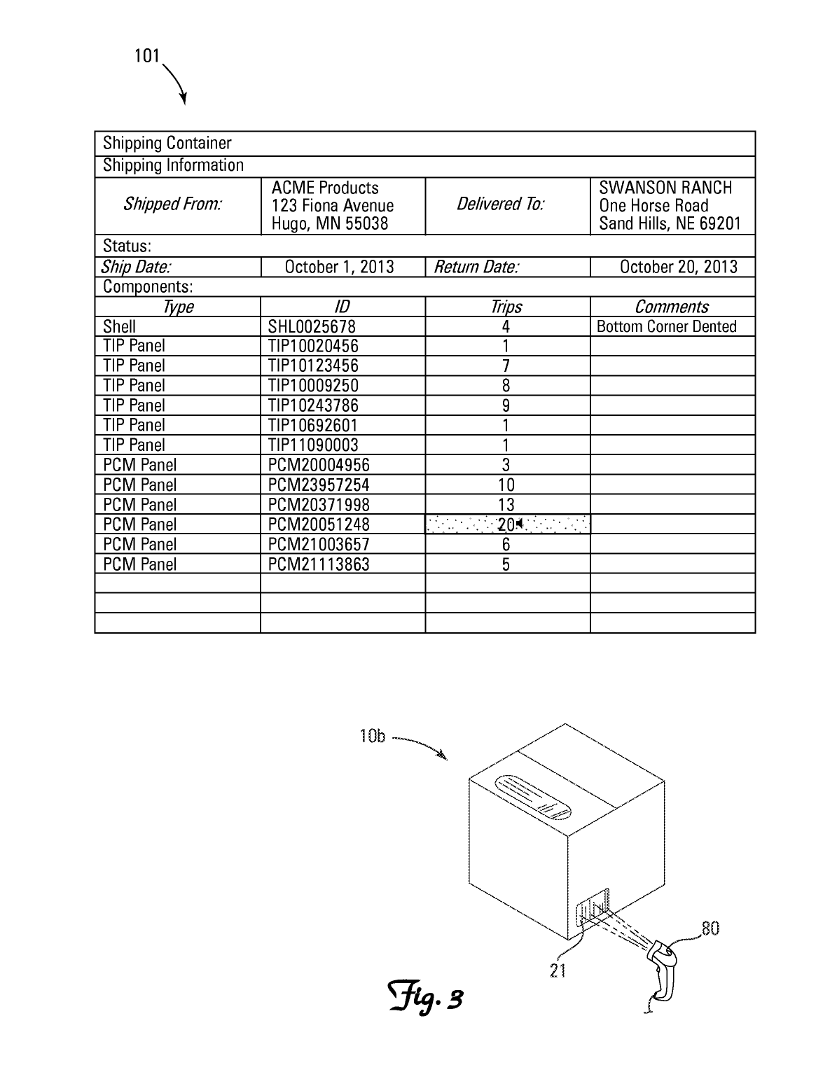

FIG. 3 depicts one embodiment of an incoming or recovered spent shipping container 10b and an exemplary trip report 101 for the incoming shipping container 10b in which the shipping container 10b has been identified as an incoming shipping container 10b, such as by inserting a return date into the proper cell in the trip report 101, the structural shell identification label 21 has been scanned with a barcode reader 80, and the trip count for all components correlated to the ID number on that structural shell identification label 21 have been automatically incremented by 1 without the need to scan the ID label on each and every component. In the event one of the components now has a trip count that exceeds a threshold number of trips at which the component is to be retired, the computer 90 may be programmed to automatically generate a real-time human perceptible notification signal, such as an audible tone and/or display of a flashing light, so that the component may be promptly identified and retired prior to being placed back into inventory.

Generally, the threshold number of trips at which each type of component is to be retired may be selected as desired by the management facility based upon past experience. Generally, outer structural shells 20 constructed from cardboard or similar low-cost materials will typically have a trip threshold of between about 2-5, while vacuum insulated TIC panels 30 will typically have a trip threshold of between about 5-10 and PCM panels will typically have a trip threshold of between about 10-30.

### Reports

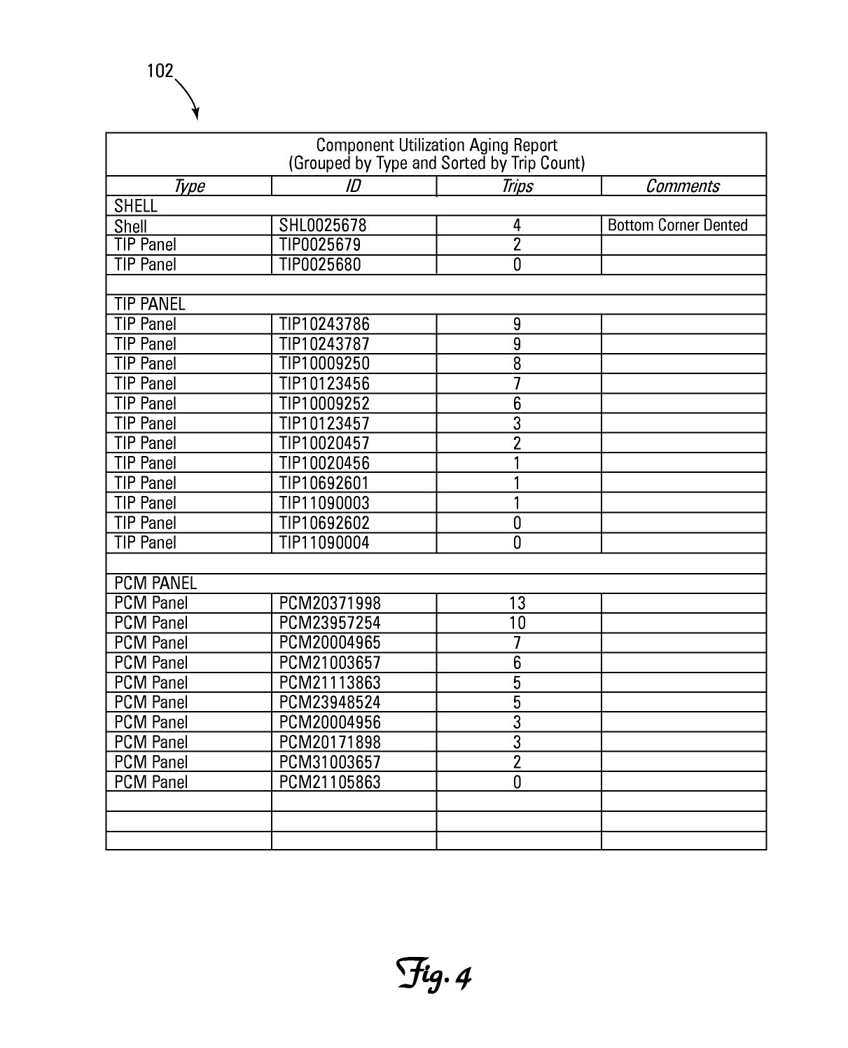

FIG. 4 depicts an exemplary component utilization ageing report 102. The computer 90 is preferably programmed to permit customizable, filterable and sortable component utilization ageing reports 102 to be generated as desired. Such reports 102 allow a management facility to quickly and accurately monitor the aging of its component inventory and plan accordingly. The component utilization ageing report 102 can provide a wide array of raw and computational data including specifically but not exclusively, a simple listing of all components with trip count, a listing of all components with an indication of number of trips remaining for each component before the component is scheduled for retirement, a component count per component type, a count or % of each type of component approaching retirement, a count of total number of trips remaining for all components of each type in inventory, etc.

1-8. (canceled)

9. A system having a computer for tracking shipping containers and components of shipping containers, the system configured to:
(a) receive, in a database of the computer, data associated with a machine readable code captured from one or more components of a shipping container, the data including an identification number associated with each component of the shipping container;
(b) associate, by the computer, a trip count with each identification number;
(c) compare, by the computer, each trip count with a corresponding predefined threshold;
(d) provide, by the computer, at least one of: (i) a component utilization report including data identifying each component that is associated with a trip count that exceeds a corresponding predefined threshold; or (ii) a signal for generating a human-perceptible notification in response to a trip count exceeding the corresponding predefined threshold.

10. A system as recited in claim 9, wherein the system includes and is configured for tracking components of passive thermal shipping containers, the components of the passive thermal shipping containers being re-usable and configured to be grouped in a variety of different collections, each collection of shipping container components forming a shipping container for a trip.

11. A system as recited in claim 10, wherein the system is configured for tracking passive thermal shipping containers and wherein:
(a) the shipping container components include at least one vacuum insulated panel (VIP) or at least one phase change material (PCM) panel on which the machine readable code is placed; and
(b) the predefined threshold corresponds to a predefined maximum number of trips in a shipping container that the VIP or PCM panel may take before it is scheduled to be retired.

12. A system as recited in claim 9, wherein the system further includes a scanning device configured to capture the machine readable code on each component of each shipping container, and provide the data associated with the captured machine readable code to the computer.

13. A system as recited in claim 9, wherein the computer provides the component utilization report including a listing of each identification number included in machine readable codes captured from one or more components, and at least one of: (i) a listing of a trip count associated with each identification number listed in the report, or (ii) a listing of one or more identification numbers for one or more components associated with a trip count that exceeds the predefined threshold.

14. A system as recited in claim 9, wherein the computer is configured to automatically increment the trip count associated with the identification number of each component, upon receiving, in a database of the computer, data associated with the machine readable code captured from the component.

15. A system as recited in claim 9, wherein the computer is configured to correlate identification numbers associated with a plurality of components that are within a same shipping container to indicate that the plurality of components are in the same shipping container.

16. A system as recited in claim 15, wherein the computer is configured to automatically increment the trip counts associated with the identification numbers of a plurality of components within the same shipping container, upon receiving, in a database of the computer, data associated with the machine readable code captured from one of the components of the shipping container.

17. A system as recited in claim 15, wherein the computer is configured to automatically increment the trip count associated with the identification number of each component within the same shipping container, upon receiving, in a database of the computer, data associated with the machine readable code captured from one of the components of the shipping container.

18. A system as recited in claim 9, further including a label having the machine readable code on each component of a shipping container.

19. A system as recited in claim 9, wherein the computer provides the signal for generating the user-perceptible notification comprising an audible tone or a light display in response to the trip count exceeding the corresponding predefined threshold.

20. A method for tracking on a computer, shipping containers and components of shipping containers, the method comprising:
(a) receiving, in a database of the computer, data associated with a machine readable code captured from one or more components of a shipping container, the data including an identification number associated with each component of the shipping container;
(b) associating, by the computer, a trip count with each identification number;
(c) comparing, by the computer, each trip count with a corresponding predefined threshold;
(d) providing, by the computer, at least one of: (i) a component utilization report including data identifying each component that is associated with a trip count that exceeds a corresponding predefined threshold; or (ii) a signal for generating a human-perceptible notification in response to a trip count exceeding the corresponding predefined threshold.

21. A method as recited in claim 20, wherein the shipping containers comprise passive thermal shipping containers and wherein the method further comprises:
(a) placing a label having the machine readable code on at least one vacuum insulated panel (VIP) or at least one phase change material (PCM) panel in a shipping container; and
(b) defining the predefined threshold to correspond to a predefined maximum number of trips that the VIP or PCM panel may take before it is scheduled to be retire.

22. A method as recited in claim 20, further comprising capturing with a scanning device the machine readable code on each component of each shipping container, and providing the data associated with the captured machine readable code to the computer.

23. A method as recited in claim 20, further comprising providing, with the computer, the component utilization report, where the component utilization report includes a listing of each identification number included in machine readable codes captured from one or more components, and at least one of: (i) a listing of a trip count associated with each identification number listed in the report, or (ii) a listing of one or more identification numbers for one or more components associated with a trip count that exceeds the predefined threshold.

24. A method as recited in claim 20, further comprising incrementing, with the computer, the trip count associated with the identification number of each component, upon receiving, in a database of the computer, data associated with the machine readable code captured from the component.

25. A method as recited in claim 20, further comprising correlating, with the computer, identification numbers associated with a plurality of components that are within a same shipping container to indicate that the plurality of components are in the same shipping container.

26. A method as recited in claim 25, further comprising automatically incrementing, with the computer, the trip counts associated with the identification numbers of a plurality of components within the same shipping container, upon receiving, in a database of the computer, data associated with the machine readable code captured from one of the components of the shipping container.

27. A method as recited in claim 25, further comprising automatically incrementing, with the computer, the trip count associated with the identification number of each component within the same shipping container, upon receiving, in a database of the computer, data associated with the machine readable code captured from one of the components of the shipping container.

28. A non-transitory computer readable-medium containing instructions such that, when executed, causes a computer to:
(a) receive, in a database of the computer, data associated with a machine readable code captured from one or more components of a shipping container, the data including an identification number associated with each component of the shipping container;
(b) associate, by the computer, a trip count with each identification number;
(c) compare, by the computer, each trip count with a corresponding predefined threshold;
(d) provide, by the computer, at least one of: (i) a component utilization report including data identifying each component that is associated with a trip count that exceeds a corresponding predefined threshold; or (ii) a signal for generating a human-perceptible notification in response to a trip count exceeding the corresponding predefined threshold.

29. A non-transitory computer readable-medium as recited in claim 28, wherein the instructions further cause the computer to correlate identification numbers associated with a plurality of components that are within a same shipping container to indicate that the plurality of components are in the same shipping container; and automatically increment the trip counts associated with the identification numbers of the plurality of components within the same shipping container, upon receiving, in a database of the computer, data associated with the machine readable code captured from one of the components of the shipping container.
